(19) United States
(12) Patent Application Publication
(10) Pub. No.: US 2017/0147160 A1
(43) Pub. Date: May 25, 2017

(54) TOUCHSCREEN INTERFACE MENU WITH VIRTUAL WHEEL

(71) Applicants: Wawa, Inc., Wawa, PA (US); Mobiquity Incorporated, Wellesley, MA (US)

(72) Inventors: Scott Andrew Snyder, Berwyn, PA (US); Andrew Capozzi, Wyomissing, PA (US); Srinivas Seeram, King of Prussia, PA (US); Scott Jaspan, Plymouth Meeting, PA (US); Michael Welsh, Collegeville, PA (US); Leigh Maxson, West Grove, PA (US)

(21) Appl. No.: 14/950,315

(22) Filed: Nov. 24, 2015

(51) Int. Cl. G06F 3/0482; G06F 3/0488; G06F 3/0484

(52) U.S. Cl. CPC G06F 3/0482; G06F 3/04842; G06F 3/04883; G06F 3/04845

(57) ABSTRACT

Items may be displayed on a selection list and at least a portion of a virtual wheel displayed on a user interface. The selection list and virtual wheel may be configured to operate in conjunction with one another. The virtual wheel may be rotationally repositioned by a first input received at the user interface to change items displayed concurrently with the rotation of the virtual wheel. A second input received at the user interface may be used to select one of the items displayed on the at least a portion of the virtual wheel as a selection associated with an item displayed on the selection list for further processing. As selections are made on the virtual wheel the selection list displays selections being made to provide a status of activity using the virtual wheel.

### BACKGROUND

Devices having touchscreen functionality have become widely used in everyday life. Devices that may utilize touchscreen functionality include devices such as smartphones, tablet computers, electronic kiosks, gaming devices, personal computers and any other type of electronic device that can be configured to receive input and display output through an interface that includes touch functionality.

As mobile device technology has advanced, the functions and applications in which devices having touch functionality are used have increased greatly in sophistication and number. This has resulted in devices being required to handle and process data input and output at a user interface in increasingly sophisticated and user friendly ways.

As a result of the wide use of touchscreen devices, and the increase in technical sophistication of these devices, it would be desirable to have a user interface that allowed users to input data to and receive data from a touchscreen in a more intuitive and organized manner than is provided by some current interfaces. Further, it would be desirable that such a user interface could be operated in a user friendly manner and was adaptable and flexible for providing interaction with various applications and operating systems to accomplish a range of functions.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Example embodiments of apparatus and methods of providing a touchscreen menu that includes a virtual wheel for a user interface display are presented in this disclosure. The menu and virtual wheel embodiments provide an intuitive and efficient way of displaying output and/or receiving input at a user interface display, for example on a touch screen of a mobile device.

In the embodiments, one or more items may be displayed on a selection list and on at least a portion of a virtual wheel displayed on a user interface. The selection list and virtual wheel may be configured to operate in conjunction with one another. For example, operations performed on the selection list may be reflected in changes to the virtual wheel and operation performed on the virtual wheel may be reflected in changes to the selection list. In one embodiment, the virtual wheel may be used to select selections that are associated with an item displayed in the selection list. The virtual wheel may be rotationally repositioned (e.g. rotated on the display) by a first input received at the user interface to change a display position of the at least one item concurrent with the rotation of the virtual wheel. A second input received at the user interface may be used to select one of the at least one items displayed on the at least a portion of the virtual wheel as a selection related to an item displayed on the selection list for further processing. The selection of one of the at least one items displayed on the at least a portion of the virtual wheel may also be used to trigger display of a second at least one item on at least a portion of a next-level virtual wheel on the display as a sub-selection associated with the item displayed on the selection list. As selections are made on the virtual wheel, the selection list displays the selections in a hierarchical manner based on the levels of the virtual wheels from which the selections are chosen to provide guidance or status on activity using the virtual wheel.

In one implementation, upon selection of an item displayed on the selection list, for example, selecting the item by touching the text on the display, the virtual wheel is displayed as the virtual wheel at the level from which that particular selection was made.

In example embodiments, the selection list and virtual wheel may be displayed, respectively, on a first and second portion of the display. The virtual wheel may comprise an outer curved border that extends from a first point to a second point on the edge of the display and the display of the virtual wheel on the user interface may only show a portion or section of the virtual wheel that is defined by the outer curved border and the location of the first and second points. The virtual wheel may also comprise an inner curved border that extends from a third point to a fourth point on the edge of the display and the section of the virtual wheel shown on the user interface may be further defined by the inner curved border and location of the third and fourth points. The selection list and virtual wheel may be displayed adjacent to one another on the display with the selection list adjacent to the outer curved border of the virtual wheel.

In other example embodiments, the rotation of the virtual wheel in response to the first input may change the display position of the virtual wheel so that a selected item of the at least one item shown on the portion of the virtual wheel before the rotation is removed from view by the rotation, and a second at least one item appears as displayed on a second portion of the wheel that appears with the rotation of the virtual wheel.

In further embodiments the virtual wheel that is displayed on the display may be laterally repositioned (e.g. slid on the display) relative to the edges of the display so that the size of the at least a portion of the virtual wheel that displays is reduced or minimized. This allows the selection list portion of the display to be displayed alone on the display. Additionally, the virtual wheel may also be slid on the display relative to the edges of the display so that the size of the at least a portion of the virtual wheel that displays is increased or maximized.

### BRIEF DESCRIPTION OF THE DRAWINGS

FIG. 1A illustrates an example interface menu having a virtual wheel display according to embodiments of the disclosure;

FIG. 1B illustrates an example interface menu having a virtual wheel next level display accessed in the embodiment of FIG. 1A;

FIG. 1C illustrates an example interface menu having a virtual wheel next level display rotated from the position shown in FIG. 1B;

FIG. 1D illustrates an example interface menu having a virtual wheel display rotated from the position shown in FIG. 1A;

FIG. 2A illustrates an example interface menu having a virtual wheel display showing the virtual wheel in a minimized position;

FIG. 2B illustrates an example interface menu having a virtual wheel display showing the virtual wheel in a maximized position;

FIG. 2C illustrates an example interface menu having a virtual wheel display showing a next-level virtual wheel;

FIG. 3A illustrates an example interface menu having a virtual wheel display in a right handed configuration;

FIG. 3B illustrates an example menu for changing from a right to a left handed selection list and virtual wheel display configuration;

FIGS. 3C-3E illustrate example operations of a selection list and virtual wheel display in a left handed configuration;

FIGS. 4A-4C illustrate an example interface menu having a virtual wheel according to another embodiment of the disclosure;

FIG. 5 illustrates an example network in which mobile devices utilizing a interface menu and virtual wheel display according to the embodiments may be operated; and,

FIG. 6 is a block diagram of an example device on which an interface menu and virtual wheel display according to the embodiments may be implemented.

### DETAILED DESCRIPTION

The system, method and apparatus will now be described by use of exemplary embodiments. The exemplary embodiments are presented in this disclosure for illustrative purposes, and not intended to be restrictive or limiting on the scope of the disclosure or the claims presented herein.

The technologies and techniques described herein provide a method and apparatus for utilizing an interface menu having a virtual display wheel on a user interface. The interface menu and virtual display wheel of the embodiments may be implemented to present output and/or receive input on devices that include functions which interact with a user interface. The menu and virtual wheel provides an intuitive way of displaying items for display and selection. For example, in an embodiment, a selection list may be displayed adjacent to the virtual wheel. As selections are made on the virtual wheel, the selection list may display the selections in a hierarchical manner based on the levels of the virtual wheels from which the selections are chosen (where the levels of the virtual wheel represent a hierarchy). Rotation of the wheel, for example by touchscreen input gesture, provides an impression of a rotating wheel that may be used to move displayed items out of view or move other selection items into view with a displayed portion of the wheel as the wheel is rotated. The selection list may provide an indication of a category of selections displayed on the virtual wheel. Multiple levels of virtual wheels may be utilized to provide different levels of item selections and sub-selections for selected items to be displayed on a selection list of the menu. The virtual wheel may be rotationally repositioned concurrent with a curved border, or an arc, that forms a border of the virtual wheel. As selections are made on the virtual wheel, the selection list displays the selections in a hierarchical manner based on the levels of the virtual wheels from which the selections are chosen. The selection list may remain in view as the virtual wheel is transitioned through multiple levels or items displayed on the virtual wheel are changed. The selection list allows a user to obtain guidance and status on the past and the current state of the virtual wheel.

The virtual wheel may be configured so that a selected size portion of the virtual wheel is displayed on the display as the wheel is rotated. In embodiments, the selected size portion displayed may be provided in different sizes by changing the position of the wheel in relation to the borders of the display. The selected size portion may also be varied in size in different embodiments by implementing virtual wheels having radius of different lengths. By varying the size of the displayed portion of the virtual wheel more display area may be available on the display for display of the selection list or other information related to an application. In other implementations, the virtual wheel also may be displayed to appear as a full circle or round wheel. The virtual wheel may also be implemented to include a sliding feature that allows the virtual wheel to be slid relative to the border of a display to be reduced or minimized, or, increased in size or maximized.

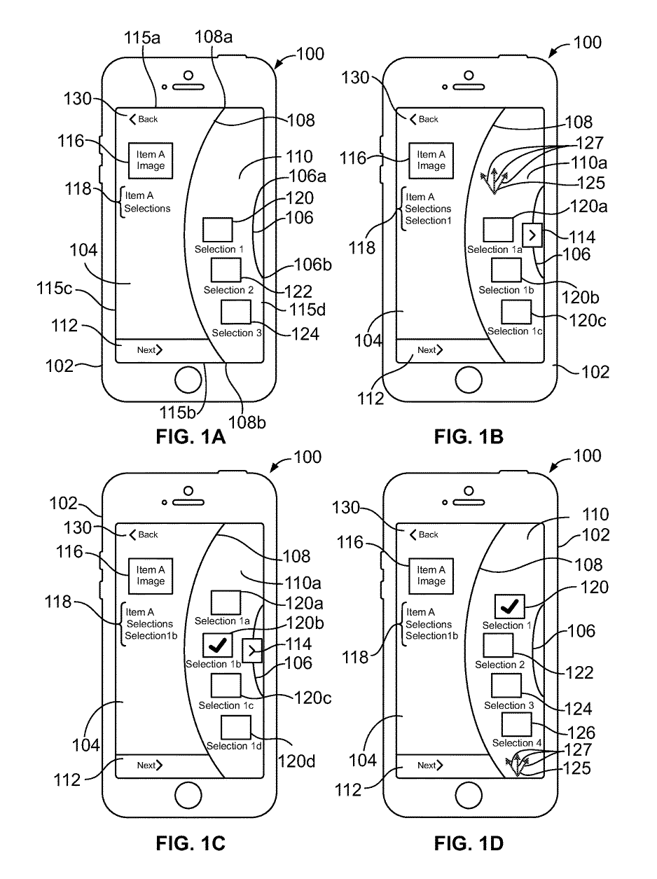

Referring now to FIG. 1A therein is illustrated an interface menu including a virtual wheel according to an example embodiment. FIG. 1A, shows device 100, which may be, for example, a smartphone, or any type of device that receives input and/or provides output through a user interface for providing services or functionality to a user. Device 100 includes casing 102 and touchscreen 104, on which output from the device may be displayed, or through which input to the device may be input. Device 100 may include processors and memory including software or code that causes the device to function to provide the interface menu display according to the example embodiment. The menu includes selection list 118 and virtual wheel 110. An indication or image of an item 116 may be displayed to indicate an item or category for which selections are being made. The virtual wheel is shown as virtual wheel 110 displayed on touch screen 104. In the embodiment virtual wheel 110 comprises a portion of a circle, or wheel on the display. Virtual wheel 110 includes outer curved border 108 and inner curved border 106. In the example embodiment of FIG. 1A, outer curved border 108 extends from a point 108a on top border 115a of display 104 to a point 108b on bottom border 115b of display 104, and, inner curved border 106 extends from a point 106a to a point 106b on right border 115d of display 104. Selection1 120, selection2 122, and selection3 124 are shown as displayed on the area of virtual wheel 110. Item A image 116, which represents an image of a particular item A, may be displayed adjacent to outer curved border 108 of virtual wheel 110. Selection list 118 describing information related to Item A selections may also displayed on display 104 adjacent to outer curved border 108 of virtual wheel 110.

FIG. 1A shows a state of an example implementation in which virtual wheel 110 may be used as an ordering or selection wheel with selection list 118 to provide a display of available first-level selections, for example selection to selection3, that are related to an item A which is displayed as the Item A image 116. In this implementation Item A may be a product, for example a sandwich on a restaurant menu, and the selections may be selections of options related to the sandwich, such as “toppings”, “bread type”, or “condiments”. Selection list 118 may be used to display current selections previously selected on the virtual wheel in the present category of selections, or other categories of selections related to Item A selectable from the virtual wheel. In some embodiments, Item A could be any type of product which has related sub-selections or options, such as color, or size, etc., or any other type of device menu item that has related selections that may be made. Selection of an item from the wheel causes processing of the selected item and listing of the item in selection list 118. This processing may include any processing in which an indication that the item was selected is used. For example, processing may include flagging or marking the selected item for purchase, marking the item for inclusion in a list or for use in modifying or qualifying other selected items, marking the item as a selection to be operated on further, initiating a function indicated by the selection, displaying information relevant to the item, or performing any other function or act in response to the item selection.

FIGS. 1A-1D show selection list 118 and virtual wheel 110 in a progression of example operations in which a selection and sub-selection of actions and options related to Item A are performed on the virtual wheel. When selection1 120 is selected by user input from the virtual wheel 110 as displayed in the example of FIG. 1A, the selection list 118 and virtual wheel 110 change to the display state shown in FIG. 1B. Selection of selection1 120 may be performed by touching the icon or image displayed for selection1 120 wherever the icon or image is displayed on virtual wheel 110. In other embodiments, the selection of selection1 120 from virtual wheel 110 may be done by other ways. For example, the selection1 120 may be positioned at a specific spot by the rotation of virtual wheel 110, such as a spot marked on the display by a selection arrow, and a selection button may be activated.

FIG. 1B shows the virtual wheel displayed as next-level virtual wheel 110a (e.g., a hierarchical sub-level virtual wheel) displaying current selections as selection1a 120a, selection1b 120b, and selection1c 120c on the virtual wheel. Selections1a 120a, selection1b 120b, and selection1c 120c may be sub-selections within the category of selection1 120. For example, in the example of the ordering wheel for a sandwich, selection 1 120 may be a higher level selection of “Toppings” and Selections1a, 1b and 1c may be next-level selection of types of toppings such as “onions”, “lettuce”, or “jalapenos”. At this stage in the selection list 118 may indicate that virtual wheel 110a is at the next-level of selecting by displaying text that reads “Selection 1” indicating the next-level selection function. Next-level virtual wheel 110a may also include a return button 114 that returns the display back to the last level (e.g. the higher hierarchical level). Selecting button 114 on the touchscreen while next-level virtual wheel 110a is displayed functions to return the virtual wheel back to display first-level virtual wheel 110. In another example embodiment, selecting an item in selection list 118, such as selecting the text or the image for Item A, may also return the virtual wheel back to display the virtual wheel for the level at which sub selections for that item are initially made.

The virtual wheel 110 in the example implementation of FIG. 1A and next-level virtual wheel 110a of FIG. 1B are configured to rotate according to input performed on touch screen 104. For example, if a user touches wheel 110a of FIG. 1B at point 125 and makes a motion or gestures on the touchscreen in the general direction shown by arrows 127, virtual wheel 110a will rotate in the direction of the motion or gestures to move the displayed items, selection1a 120a, selection1b 120b, and selection1c 120c, in a clockwise rotational motion on the touchscreen 104. The rotation of virtual wheel 110a, or the displayed portion of virtual wheel 110a, will be concurrent with the outer curved border 108 and inner curved border 106, and, the displayed position of selection1a 120a, selection1b 120b, and selection1c 120c will move concurrently with the rotation of the virtual wheel 110a, as if the items were positioned on a circular table or ring that was being rotated.

Referring now to FIG. 1C, FIG. 1C illustrates the example selection list 118 and next level virtual wheel 110a as rotated from the position shown in FIG. 1B subsequent to a rotation in the clockwise direction. In FIG. 1C wheel 110a is shown displaying selection1a 120a, selection1b 120b, and selection1c 120c with displayed positions rotated according to and concurrent with the rotation of virtual wheel 110a relative to FIG. 1B. FIG. 1C also shows selection1d 120d which has come into view on the portion of the virtual wheel 110a that is shown on the touchscreen with the rotation of virtual wheel 10a in the clockwise direction. Selection 1d 120d was previously hidden from view on the portion of virtual wheel 110a shown in FIG. 1B.

When virtual wheel 110a is in the position shown in FIG. 1C, selection1b 120b may be selected as shown by the checkmark in Section1b 120b. At this point selection list 118 indicates that selection1b 120b has been chosen for Item A. In example implementations, the indication of a particular selection being made on virtual wheel 110 may be shown in any appropriate manner. This may include highlighting the item, changing the appearance of the item, or any other way of conveying an indication of the selection to a user. If the embodiment is configured so that multiple sub-selections may be made from the next-level virtual wheel 110a for selection1 120, the user may make multiple sub-selections that may be displayed in selection list 118 and then select button 114 to move back to the first-level virtual wheel 110 when all sub-selections have been made. Alternately, if only one sub-selection may be made, the selection would be displayed in selection list 118 and first-level virtual wheel 110 may be automatically displayed upon selection of the item. If the user desires to change their selection, the user may select selection1 again or select back 130 to move back to virtual wheel 110a. In example implementations, the selection of selection 1 to return from virtual wheel 110 to virtual wheel 110a may be made on the virtual wheel 110 or on selection list 118. When the sub-selections have been made selection list 118 and first-level virtual wheel 110 will then display as is shown in FIG. 1D.

FIG. 1D illustrates selection list 118 and virtual wheel 110 as displayed upon return from the next-level virtual wheel 110a and a subsequent rotation from the position of virtual wheel 110 shown in FIG. 1A. FIG. 1D shows a checkbox displayed in selection1 120 to indicate that selection1 120 is still selected upon return from the next-level wheel 110a. In other example implementations, the indication that selection 1 is selected may be shown in any appropriate manner. In the implementation, rotation of virtual wheel 110 may be performed, for example, by a touchscreen motion or gesture made on point 125 in the general direction of lines 127 on virtual wheel 110 as shown in FIG. 1D to cause rotation in the clockwise direction. FIG. 1D shows the positions of selection1 120, selection2 122, and selection3 124 changed concurrent with a rotation of virtual wheel 110 that has been made in a clockwise direction as compared to FIG. 1A. Virtual wheel 110 also displays selection4 126 which has come into view on the portion of the virtual wheel 110 that is shown on the touchscreen subsequent to the rotation of virtual wheel 110 in the clockwise direction. Selection4 126 was previously hidden from view on the portion of virtual wheel 110 shown in FIG. 1A. In the embodiments, rotation may be performed in either the clockwise or counter-clockwise directions using appropriately directed input gestures anywhere on the virtual wheel. By rotating the virtual wheel 110 or virtual wheel 110a in this manner items may be brought into view for selection as the wheel rotates and items previously displayed may be minimized from view.

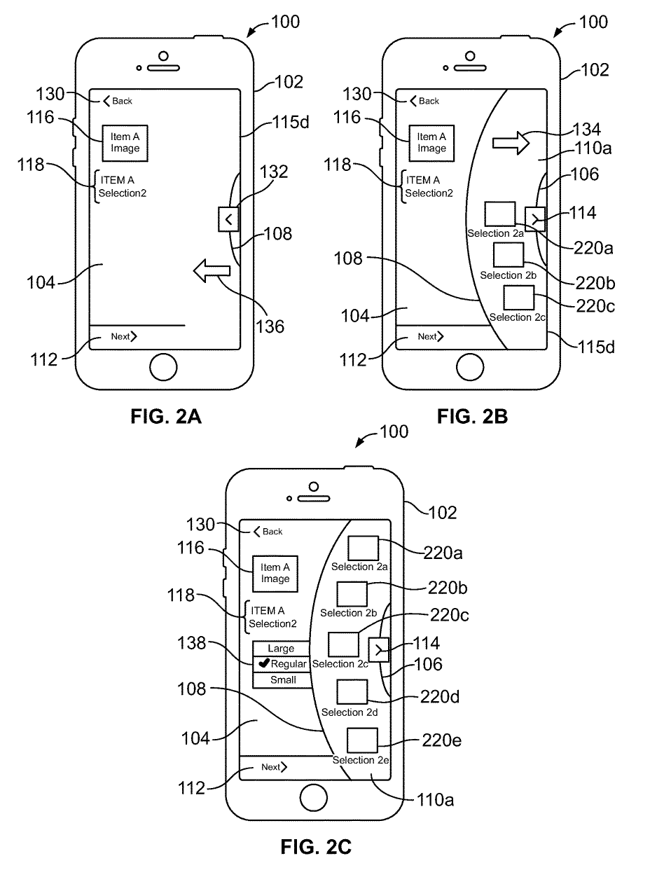

Referring now to FIG. 2A, therein is illustrated an example menu having a virtual wheel displayed showing the virtual wheel removed from view on the display in a reduced portion or minimized position. FIG. 2A shows an example of how the display on device 100 may appear when next-level virtual wheel 110a has been put in the reduced or minimized position. This provides a clear view of current selections in selection list 118 uncluttered by virtual wheel 110. The reduced portion or minimized position may be utilized for any level of virtual wheel. Referring to FIG. 2B, when a user is operating on virtual wheel 110a, virtual wheel 110a may be slid into a reduced portion or minimized position by applying a touchscreen gesture on the wheel 110a in the direction shown by arrow 134 to slide or laterally reposition virtual wheel 110a into right side border 115d. The display may then appear as shown in FIG. 2A with virtual wheel 110a reduced in size or minimized from view. Touchscreen 104 may display relevant items 116 or selection list 118 not shown on the virtual wheel. The virtual wheel 110a may be brought back into view in the increased portion size or maximized position of FIG. 2B by pressing button 132 to cause the virtual wheel to slide or laterally reposition out from right side border 115d in the direction shown by arrow 136 shown on FIG. 2A. In embodiments, each of the virtual wheels at multiple selection levels may be moved between minimized and maximized, or reduced and increased, size portion positions in this manner to show and hide the wheel. Any other type of gesture may also be used on the touchscreen to cause the movement. Also the virtual wheel may be displayable at positions other than a maximized or minimized position, such as in one or more intermediate positions. These reduced size or minimized positions of virtual wheel 110a allow the selection list 118 and Item A image 116 to be displayed without the virtual wheel 110a obscuring or distracting from the view of selection list 118 and image 116. For example, if text in the selection list 118 does not display fully when virtual wheel 110a is the maximized position, repositioning the wheel to the minimized position may allow that text to become visible.

FIG. 2C illustrates an example menu having a virtual wheel displayed showing next-level virtual wheel 110a having a selection drawer 138 (e.g. a selection menu) for complex item sub-selections. FIG. 2C shows selection list 118 indicating selection2 is the current selection. Items selection2a 220a-selection2e 220e are displayed for selection on virtual wheel 110a as sub-selections of selection2 of a first level wheel such as virtual wheel 110 of FIG. 1A. In FIG. 2C virtual wheel 110a has been rotationally repositioned in a clockwise direction, as compared to FIG. 2B, to move the positions of selection1 220a-selection3 220c with the rotation of virtual wheel 110a, and also to move selection2d 220d and selection2e 220e into view.

When a selection is selected from virtual wheel 110a in FIG. 2C, if the selection is a type of selection that requires a choice or allows further qualification, a drawer 138 may be presented on touchscreen 104 so that further input may qualify the selection. In the example implementation shown in FIG. 2C, selection2c 220c has been selected and drawer 138 is displayed so that a choice of “large”, “regular”, or “small” may be made to further qualify selection2c 220c. In embodiments, the drawer feature may be used when necessary to qualify a selection. The selection made on the drawer 138 may be shown in selection list 118. As an alternative, further levels of virtual wheels may be also used to further describe a selection. For example, in one implementation selection of a selection on virtual wheel 110a may lead to a third—level virtual wheel (e.g. a lower hierarchical level) to allow input to further qualify the selection, such as for example, by displaying size selections for selection2c 220c. The drawer feature may be implemented when the number of alternatives to be presented is a number that can be conveniently presented in selection drawer 138. This may allow a selection to be further described in a simpler manner, rather than implementing further levels of virtual wheels for each item on virtual wheel 110a.

The embodiments of FIGS. 1A-1D and FIGS. 2A-2C have been disclosed showing a menu having a virtual wheel that is configured for a right-handed user. When the display is in the right handed configuration a right handed user may hold the device in their right hand and operate the virtual wheel 111 with their right hand, for example, with the right thumb. Their left hand, for example their left index finger, may then be used to select from the selection list 118. Because the virtual wheel in the right-handed configuration is conveniently rotated by a touchscreen gesture including motions made with the right hand on the right-hand side of the touchscreen while leaving the remainder of the display in view, left-handed users may not find the right-handed configuration convenient. A left-handed user may find touchscreen gestures using motions on the left hand side of the touch screen easier to use on the virtual wheel. Embodiments of the virtual wheel may be implemented that provide a feature that allows the virtual wheel to be configured in either a right or left handed configuration.

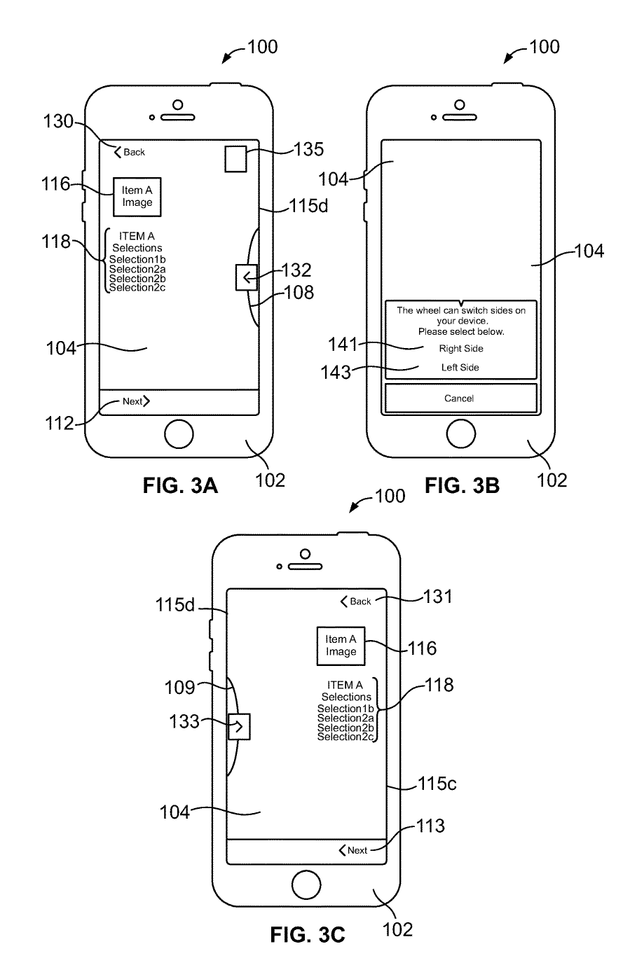

FIG. 3A illustrates an example interface menu having a virtual wheel display in a right handed configuration. This is basically a similar view as shown in FIG. 2A reversed. Selection list 118 shows example selections that have been made for item A 116 as a user has progressed through the various levels of virtual wheels and made the selections. In the example of FIG. 3A, selection1 has been selected as subselection 1b and selection2 has been selected as multiple subselections 2a-2c.

Referring now to FIG. 3B, therein is illustrated an example menu for changing from the right handed selection list 118 and virtual wheel of FIG. 3A to a left handed selection list and virtual wheel display configuration. Upon tapping or selecting handedness switch button 135, while in the minimized position of FIG. 3A, a menu is presented on the touchscreen display 104 prompting a user to choose right side 141 or left side 143. When left side is chosen the selection list 118 and virtual wheel 111 will be displayed in a mirror image of the right sided view and in a position more convenient to left-handed users. FIGS. 3C-3E illustrate example operations on selection list 118 and virtual wheel 111 displayed in a left handed configuration with the virtual wheel 111 defined by the outer curved border 109 and inner curved border 107. FIG. 3C shows the minimized or reduced portion size view of a virtual wheel in a left-handed configuration in which the positions of objects on display 104 is basically switched right to left so that the virtual wheel is minimized in left border 1 15c of touchscreen 104. FIG. 3D is the left-handed configuration in a similar state as shown in FIG. 1A for the right handed configuration. FIG. 3E is the left handed configuration in a similar state as shown for the right handed configuration of FIG. 2C. The functionality of the configurations is equivalent. When the display is in the left handed configuration a left handed user may hold the device in their left hand and operate the virtual wheel 111 with their left hand, for example, with the left thumb. Their right hand, for example their right index finger, may then be used to select from the selection list 118.

While the embodiments have shown the selection list and virtual wheel in right and left hand configurations with the selection list displayed, respectively, to the left and right side of the virtual wheel, alternative implementations with other positioning are possible. For example, the virtual wheel may extend from the top border of a touch screen display with the selection list beneath and adjacent to the virtual wheel, below the outer border of the virtual wheel. In another example, the virtual wheel may extend from the bottom border of a touch screen display with the selection list above and adjacent to the virtual wheel, above the outer border of the virtual wheel.

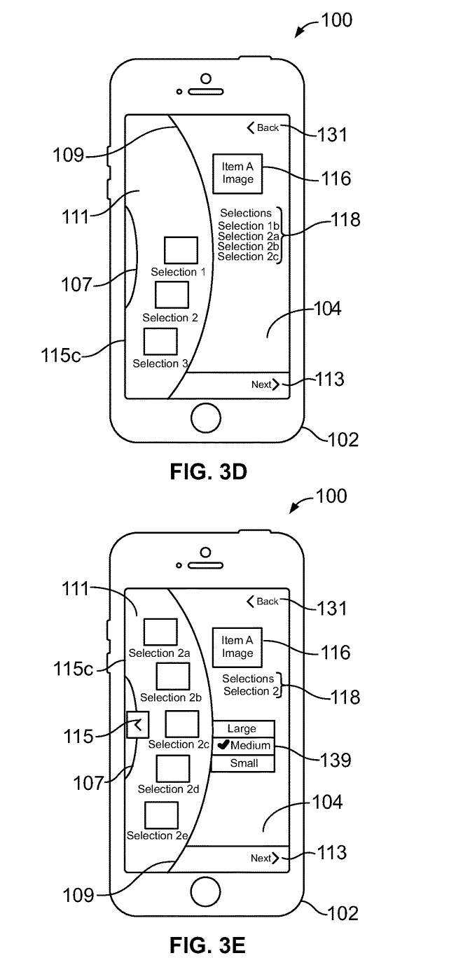

Referring now to FIGS. 4A-4C therein is illustrated an example virtual wheel according to another embodiment of the disclosure. FIGS. 4A-4C illustrate virtual wheel 411 in various states of rotation. Virtual wheel 114 may be used in conjunction with an item, or image, and selection list, such as Item A image 116 and selection list 118 of FIG. 1a, displayed on the display adjacent to virtual wheel 411. Virtual wheel 411 may be to be of a size that allows Item A image 116 selection list 118 to be appropriately viewed. Virtual wheel 411 comprises outer curved border 408 and inner curved border 406. Outer curved border 408 runs from a point 408a on right border 415d of display 404 to a second point 408b on right border 415d of display 404, and, inner curved border 406 runs from a point 406a on right border 415d to a second point 406b on right border 415d of display 404.

Referring now to FIG. 4A, FIG. 4A shows virtual wheel 411 in a position in which selection items 410, 412, 414, 416, and 418 are displayed on virtual wheel 411. Virtual wheel 411 is positioned so that only a portion of selection item 410 is displayed. Virtual wheel 411 may be rotated in the direction shown by arrows a, b and c by using touch gestures on the virtual wheel 411 on touch screen 404. The rotation of the virtual wheel 411 is concurrent with outer curved border 408 and inner curved border 406. This rotation changes the position of selection items 410, 412, 414, 416 and 418 on the display concurrent with the rotation of the virtual wheel 411.

FIG. 4B shows an example position of virtual wheel 411 after rotation in the direction shown by arrows a, b and c of FIG. 4A. In FIG. 4B virtual wheel 411 has been rotated so that selection items 412, 414, 416 and 418 are shown on the portion of virtual wheel 411 now shown on display 404, and the positions of the selection items have moved concurrent with the rotation of virtual wheel 411. The rotation has also moved the portion of selection item 410 displayed in FIG. 4A from view. Virtual wheel 411 may then be rotated from the example position shown in FIG. 4B by applying touchscreen gestures to rotate virtual wheel 411 in the counter-clockwise direction shown by arrows d, e and f.

FIG. 4C shows an example position of virtual wheel 411 after rotation in the direction shown by arrows d, e and f of FIG. 4B. In FIG. 4C virtual wheel 411 has been rotated so that selection items 412 and 414 are shown on the portion of virtual wheel 411 now shown on display 404, and the positions of items 412 and 414 have moved concurrent with the rotation of virtual wheel 411. The rotation has also moved selection item 410 back into view and the whole of selection item 410 is now displayed. Selection items 416 and 418 have moved out of view. Selection items 426 and 428, which were minimized in the previous views of FIGS. 4A and 4B, have also come into view on the displayed portion of virtual wheel 411 as the wheel is rotated in the counter-clockwise direction.

In example implementations the virtual wheel may be configured to display items of a set number of items that may disappear and reappear in view again as the virtual wheel is rotated continually in one direction or back and forth. Alternately, in other implementations, the virtual wheel may be configured to display items from a set of any number of items, for example, hundreds or thousands or a set of indefinite number, that appear and disappear from view as the wheel is rotated, but that may or may not reappear on the virtual wheel depending on the desired implementation.

In further example implementations the selection list and the virtual wheel may be combined with and implemented using touch sensing display technologies, such as, for example, force-touch or force-sensitive technology to provide additional features. These technologies could be used, for example, in a virtual wheel implementation such as that shown in FIGS. 1A-1D. In this case, when an selection item is displayed on the selection list or on the wheel, such as selection 1 in FIG. 1A, the application of a force touch to the selection item may be sensed and used to determine that additional information related to selection 1 has been requested. For example, if selection 1 was a choice of bread to go with item A (a meal) as shown in FIG. 1A, the sensing of a force touch at a predetermined pressure could cause processing of the selection to cause nutritional information about selection 1, such as calorie count, protein content, etc., to be displayed on the display. The information may be displayed, for example, on the selection list or in a defined area on the display such as a pop-up or message bubble. The sensing of a force touch at another predetermined pressure could be used to determine that selection 1 has been selected and cause processing to change the display to the display shown in FIG. 1B. The force sensing may use force sensing amount and/or time duration to determine what input is being or has been made on displayed wheel selections. The use of force sensing or force-sensitive-technologies may be implemented in various ways to add additional features to embodiments of the virtual wheel.

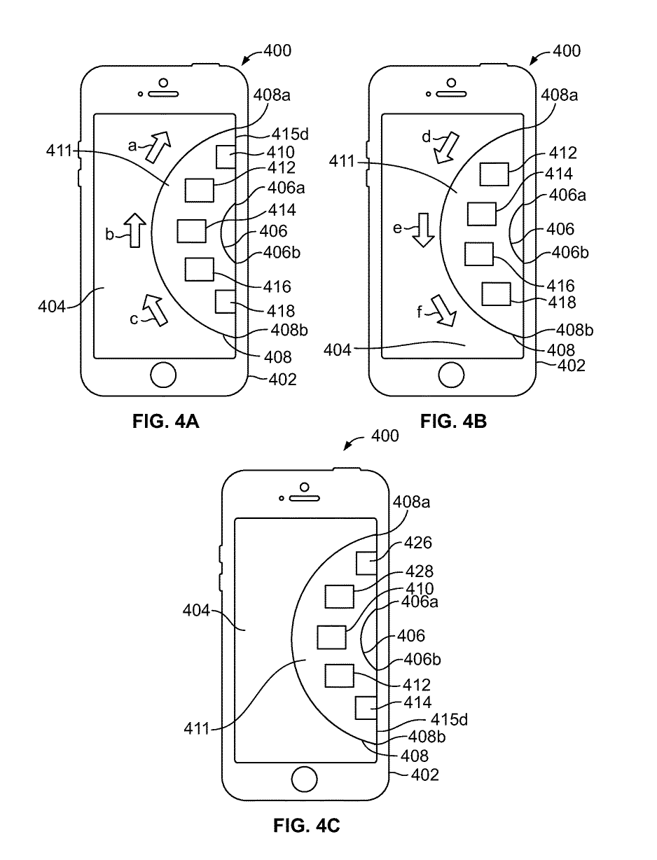

Referring to FIG. 5, therein is illustrated an example network in which mobile devices utilizing a menu and a virtual wheel display according to the embodiments may be operated.

System 500 is shown as including communication networks 514, a server 510 that is coupled to storage devices 520a and 520b, a server 512 that is coupled to storage devices 522a and 522b, smartphone 502, tablet device 504, and laptop computer 506. The communications networks 514 provide connectivity for communications between smartphone 502, tablet device 504, laptop computer 506, servers 510 and 512, and other devices that may be connected to communications networks 514. Communication networks 514 may include one or more internet protocol (IP) networks comprising routers and switches for routing internet traffic carried in IP data packets and is not limited to a particular type of network Communication network 514 also may include one or more wireless or landline networks that provide the network interfaces shown at interfaces a-e for, respectively, smartphone 502, tablet device 504, laptop computer 506 and servers 510 and 512 to communications network 514. The wireless or landline networks of communications networks 514 that provide interfaces a-e may be comprised of any type of network that provides an appropriate network interface. For example interfaces a and b for smartphone 502, tablet device 504 and laptop computer 508 may be implemented on a wireless channel provided by a cellular network or on a Wi-Fi channel provided by a Wi-Fi access point of communications networks 514.

In an example embodiment implemented in the system of FIG. 1, devices 502 504 and 506 may be configured to allow a user to utilize a selection list and a virtual wheel on a touchscreen interface of the device to receive services, control communications and/or control other device functions. For example, server 512 and storage devices 522a and 522b may be implemented to control a customer ordering function for a retail outlet or a restaurant that interfaces with an application using a virtual wheel on devices, 502, 504 or 506. The server 512 and storage devices 522a and 522b may be located on premises or off-premises and communicate with devices 502, 504 or 506 through the internet. Server 510 and storage devices 520a and 520b may also provide similar services.

An example implementation for a system utilizing a virtual wheel may be, for example, a sandwich shop that provides a selection list and the virtual wheel as an “ordering wheel”. For example, server 510 and storage devices 520a and 530b may be implemented to control a local or national a sandwich shop chain center for interfacing with an ordering wheel function that is installed on customer devices. In an implementation, the virtual wheel functions may be provided by allowing a device user to download an ordering wheel application onto a device, such a smartphone 502, table device 504 or laptop 506, through the internet. The user may be then assigned a user name and/or password and use the ordering wheel to pre-order food orders or order food on the shop premises using the device. The selection list and virtual wheel may provide an intuitive interface and easy to use features that are suited to food selection. For example, the ordering wheel may be configured with images of possible selections or sub-selections at the different virtual wheel levels to provide the impression of a table that may be rotated to place food into position for selection. The selection list may be configured to provide a device user with a status summary or progress history of selections made on the virtual wheel.

While smartphone 502, tablet device 504, and laptop 506 are each illustrated as implemented as a particular type of device, the devices may be implemented as any type of device that may be configured with appropriate functionality for supporting the virtual wheel interface, including, a portable tablet computer, a laptop or desktop personal computer (PC), a multimedia/gaming device, a smart television, home theater system, a smart automobile system, a smart house system, a multimedia cable/television box, a smart phone, a tablet computing device, a personal digital assistant (PDA), a portable media player, a smart watch, etc.

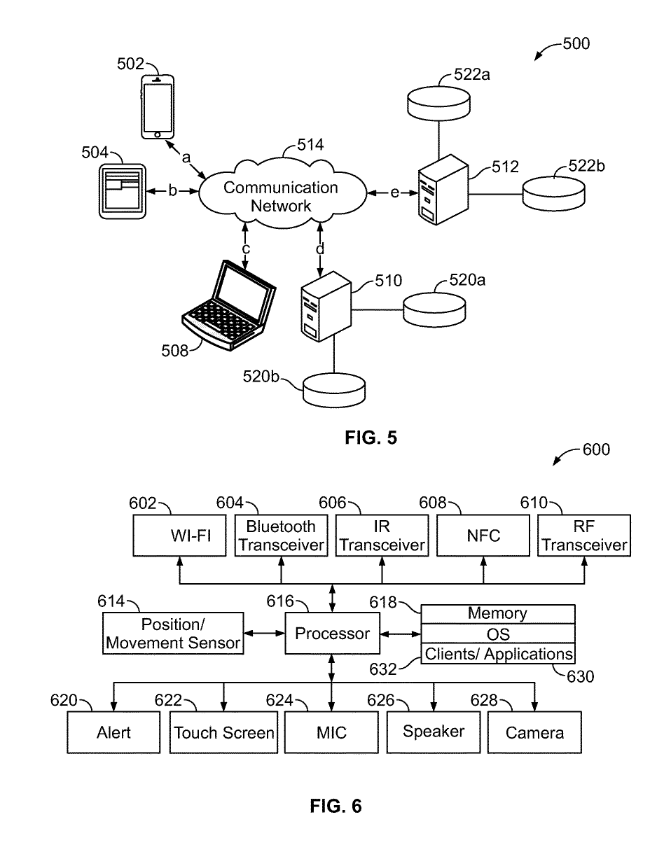

Referring now to FIG. 6, therein is an example block diagram of a device 600, according to which a device utilizing a virtual wheel according to the embodiments may be implemented. Various implementations of the devices may differ and may each include more or less functions than, or variations of, the functionality shown by the blocks in FIG. 6. Device 600 may include processor 616, which, while shown as one functional block, may be implemented by, and may comprise, one or more processors, and use of the term processer is meant to cover all such implementations. Device 600 also includes memory 618 which may be implemented as any type of storage in device 600, including non-volatile and volatile memory. Memory 618 includes instructions in the form of code for running the operating system and other applications in conjunction with processor 616 to control the operations of device 600. Memory 618 also may include data such as media data, camera photos and videos, contact data, calendar data, and other files used in the operation of computing device 600. Device 600 may also include a client, shown by the functional block 630 which is implemented by processer 616 and execution of code in memory 618. In an implementation of device 502, 504 or 506 according to device 600 of FIG. 6, processor 616, memory 618 and client 630 may be configured to control the device to implement a selection list and virtual wheel function on touchscreen 622. Client 630 may be downloaded as an application to device 600 by a user or installed by any other means. Client 630 may be a customized application provided by, for example, a particular restaurant or product provider. In one alternative implementation, client 630 may be configured as part of the operating system of device 600.

The touchscreen/keypad 622 may be implemented as a user interface, for example as a separate touchscreen or keypad, or as a touch screen, that may have a virtual keypad capability, and that may interact with client 630 and other functions of device 600 to provide the input/output functions of the selection list and virtual wheel.

Processor 616 controls data reception and transmission over communication interfaces that may be used to share and receive content for the virtual wheel according to the embodiments and may include, for example, physical connectors 602, Bluetooth transceiver 604, infrared (IR) transceiver 606, near field communications (NFC) function 608, RF transceiver 610, Wi-Fi interface 611 or Wi-Fi-direct interface 615. Processor 616 may also interface with and control global positioning service (GPS) receiver 612 and position/movement sensor 614. RF transceiver 610 and Wi-Fi interface 611 may enable wireless communication and file transfer with other devices or networks, such as network 614 according to various communication technologies, such as, for example, LTE, CDMA, TDMA or GSM/UMTS cellular, and IEEE 802.11 Wi-Fi, or other wireless technologies. Processor 616 may communicate with and control alert 620, which may be a vibrator or audio alert to alert of received shared content, touch screen/keypad 622, speaker 626, microphone 624, and camera 628. Implementations of the virtual wheel client 630 may combine use of these various interfaces and functions to provide services. For example, various restaurants or food shops may use a different ones of the interfaces, cellular, NFC, Bluetooth, Wi-Fi, or Wi-Fi-direct, etc., to implement communications between a server, such as server 510 or 512, and a device from which an order made on a virtual wheel is received.

The example embodiments of the virtual wheel disclosed herein have been described in the general context of processor-executable code or instructions stored on memory that may comprise one or more computer readable storage media (e.g., tangible non-transitory computer-readable storage media such as memory 618. As should be readily understood, the terms “computer-readable storage media” or “non-transitory computer-readable media” include the media for storage of data and program instructions, such as memory 618, and do not include propagated or modulated data communication signals.

While the functionally disclosed herein has been described by illustrative example using descriptions of the various components and devices of embodiments by referring to touchscreen display configurations, functional blocks and processors or processing units, and memory including instructions and code, the functions and processes of the embodiments may be implemented and performed using any type of suitable user interface, processor, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc.

Also, although the subject matter has been described in language specific to structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the communication process, these elements, and operations may be replaced by any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A device comprising:
a user interface for receiving input and presenting output, and having a display; and
a processor and memory including code, the code executable to cause the processor to control the device to:
display a plurality of items on at least a portion of a virtual wheel on the display;
display a selection list on the display, the selection list including information associated with at least one of the plurality of items on the virtual wheel;
receive a first input at the user interface, and in response to the first input, rotationally reposition the virtual wheel to change a display position of the plurality of items concurrent with the rotational repositioning of the virtual wheel;
receive a second input at the user interface, the second input selecting at least one of the plurality of items from the virtual wheel for processing; and,
display, in response to receiving the second input, an indication in the selection list of the at least one of the plurality of items selected for processing.

2. The device of claim 1, wherein the code is further executable to cause the processor to control the device to display the selection list adjacent to the virtual wheel, wherein the virtual wheel comprises an outer curved border that extends from a first point to a second point on a border of the display and, in response to the first input, rotate the virtual wheel concurrent with the outer curved border.

3. The device of claim 2, wherein the code is further executable to cause the processor to control the device to display the virtual wheel comprising an inner curved border that extends from a third point to a fourth point on the border of the display and, in response to the first input, rotate the virtual wheel concurrent with the inner curved border.

4. The device of claim 1, wherein the code is further executable to cause the processor to control the device to receive a third input at the user interface, and in response to the third input, laterally reposition the at least a portion of the virtual wheel on the display relative to a border of the display so that the size of the at least a portion of the virtual wheel is reduced and the selection list remains displayed on the display.

5. The device of claim 4, wherein the code is further executable to cause the processor to control the device to receive a fourth input at the user interface, and in response to the fourth input, laterally reposition the at least a portion of the virtual wheel on the display relative to a border of the display so that the size of the at least a portion of the virtual wheel is increased on the display.

6. The device of claim 1, wherein the plurality of items comprises a first plurality of items, the virtual wheel comprises a first level virtual wheel and the code is further executable, in response to the second input selecting the at least one of the first plurality of items, to cause the processor to control the device to
display a second plurality of items associated with the at least one of the first plurality of items on at least a portion of a second level virtual wheel on the display;
receive a third input at the user interface, the third input selecting at least one of the second plurality of items from the second level virtual wheel for processing; and,
and, in response to receiving the third input, displaying an indication of the at least one of the second plurality of items selected for processing in the selection list.

7. The device of claim 1, wherein the at least a portion of a virtual wheel comprises a first portion of a virtual wheel and wherein the rotational repositioning of the virtual wheel, in response to the first input, changes the display position of the virtual wheel so that a first item of the plurality of items on the first portion of the virtual wheel is removed from view and a second item not displayed with the plurality of items before rotational repositioning is displayed on a second portion of the wheel that appears with the rotation of the virtual wheel.

8. The device of claim 1, wherein the code is further executable to cause the processor to control the device to display the selection list and the at least a portion of the virtual wheel in a left hand or right hand configuration.

9. A method for displaying a virtual wheel for item selection on a display comprising:
displaying a plurality of items on at least a portion of a virtual wheel on a display of a user interface;
displaying a selection list on the display, the selection list including information associated with at least one of the plurality of items on the virtual wheel;
receiving a first input at the user interface;
rotationally repositioning, in response to receiving the first input, the virtual wheel to change a display position of the plurality of items concurrent with the rotational repositioning of the virtual wheel;
receiving a second input at the user interface, the second input selecting at least one of the plurality of items from the virtual wheel for processing, and,
displaying, in response to receiving the second input, an indication in the selection list of the at least one of the plurality of items selected for processing.

10. The method of claim 9, wherein the selection list is displayed adjacent to the virtual wheel, and wherein the virtual wheel comprises an outer curved border that extends from a first point to a second point on a border of the display and the rotationally repositioning comprises rotating the virtual wheel concurrent with the outer curved border.

11. The method of claim 10, wherein the virtual wheel further comprises an inner curved border that extends from a third point to a fourth point on a border of the display and the rotating comprises rotating the virtual wheel concurrent with the inner curved border.

12. The method of claim 9, further comprising receiving a third input at the user interface, and in response to the third input, laterally repositioning the at least a portion of the virtual wheel on the display relative to a border of the display so that the size of the at least a portion of the virtual wheel is reduced and the selection list remains displayed on the display.

13. The method of claim 12, further comprising receiving a fourth input at the user interface, and in response to the fourth input, laterally repositioning the at least a portion of the virtual wheel on the display relative to a border of the display so that the size of the at least a portion of the virtual wheel is increased on the display.

14. The method of claim 9, wherein the plurality of items comprises a first plurality of items, the virtual wheel comprises a first level virtual wheel and the method further comprises, in response to the second input selecting at least one of the first plurality of items:
displaying a second plurality of items associated with the at least one of the first plurality of items on at least a portion of a second level virtual wheel on the display;
receiving a third input at the user interface, the third input selecting at least one of the second plurality of items from the second level virtual wheel for processing; and,
displaying, in response to receiving the third input, an indication of the at least one of the second plurality of items selected for processing in the selection list.

15. The method of claim 9, wherein the at least a portion of a virtual wheel comprises a first portion of a virtual wheel and the rotationally repositioning comprises rotationally repositioning, in response to the first input, the virtual wheel to change a display position of the virtual wheel so that a first item of the plurality of items is removed from view and a second item not displayed with the plurality of items before rotation is displayed on a second portion of the wheel that appears with the rotational repositioning of the virtual wheel.

16. The method of claim 9, further comprising displaying selection list and the at least a portion of the virtual wheel in a left hand or right hand configuration based on a left or right hand configuration selection.

17. A non-transitory computer readable medium with instructions stored thereon, that when executed by a processor cause the processor to:
display a plurality of items on at least a portion of a virtual wheel on a display of a user interface;
display a selection list on the display, the selection list including information associated with at least one of the plurality of items on the virtual wheel;
receive a first input from the user interface, and in response to the first input, rotationally reposition the virtual wheel to change a display position of the plurality of items concurrent with the rotation of the virtual wheel; and,
receive a second input from the user interface and, in response to the second input, select at least one of the plurality of items from the virtual wheel for processing; and,
display, in response to receiving the second input, an indication in the selection list of the at least one of the plurality of items selected for processing.

18. The non-transitory computer readable medium of claim 17, wherein the instructions further cause the processor to display the selection list adjacent to the virtual wheel, and the virtual wheel comprises an outer curved border that extends from a first point to a second point on a border of the display and rotate the virtual wheel concurrent with the outer curved border.

19. The non-transitory computer readable medium of claim 18, wherein the virtual wheel further comprises an inner curved border that extends from a third point to a fourth point on a border of the display, and the instructions cause the processor to, in response to the first input, to rotate the virtual wheel concurrent with the inner curved border.

20. The non-transitory computer readable medium of claim 17, wherein the instructions further cause the processor to receive a third input at the user interface, and in response to the third input, laterally reposition the at least a portion of the virtual wheel on the display relative to a border of the display so that the size of the at least a portion of the virtual wheel is reduced and the selection list remains displayed on the display.

21. The non-transitory computer readable medium of claim 20, wherein the instructions further cause the processor to receive a fourth input at the user interface, and in response to the fourth input, laterally reposition the at least a portion of the virtual wheel on the display relative to a border of the display so that the size of the at least a portion of the virtual wheel is increased on the display.

22. The non-transitory computer readable medium of claim 17, wherein the plurality of items comprises a first plurality of items, the virtual wheel comprises a first level virtual wheel and the instructions further cause the processor to, in response to the second input selecting at least one of the first plurality of items:
display a second plurality of items associated with the at least one of the first plurality of items on at least a portion of a second level virtual wheel on the display;
receive a third input at the user interface, the third input selecting at least one of the second plurality of items from the second level virtual wheel for processing; and,
display, in response to receiving the third input, an indication of the at least one of the second plurality of items selected for processing in the selection list.

23. The non-transitory computer readable medium of claim 17, wherein the at least a portion of a virtual wheel comprises a first portion of a virtual wheel and wherein the rotational repositioning of the virtual wheel, in response to the first input, changes the display position of the virtual wheel so that a first item of the plurality of items on the first portion of the virtual wheel is removed from view and a second item not displayed with the plurality of items before rotational repositioning is displayed on a second portion of the wheel that appears with the rotation of the virtual wheel.
